(19) United States
(12) Patent Application Publication
(10) Pub. No.: US 2017/0075063 A1
(43) Pub. Date: Mar. 16, 2017

(54) ASYMMETRIC WAVEGUIDE CONFIGURATION ON A SILICON NITRIDE BASIS

(71) Applicant: Huawei Technologies Co., Ltd., Shenzhen (CN)

(72) Inventors: Joost Brouckaert, Gent (BE); Tom Collins, Munich (DE)

(21) Appl. No.: 15/274,341

(22) Filed: Sep. 23, 2016

Related U.S. Application Data
(63) Continuation of application No. PCT/CN2015/072814, filed on Feb. 11, 2015.

(30) Foreign Application Priority Data
Mar. 26, 2014 (EP) 14161764.7

(51) Int. Cl. G02B 6/126; G02B 6/125; G02B 6/28; G02B 6/122; G02B 6/27

(52) U.S. Cl. CPC G02B 6/126; G02B 6/1228; G02B 6/2726; G02B 6/2766; G02B 6/2773; G02B 6/2813; G02B 6/125

(57) ABSTRACT

A polarization dependent mode converter is provided on a semiconductor basis, having a waveguide made of a waveguide material comprising SiNₓ, or another solid waveguide material having a refractive index between 1.7 to 2.3, embedded in a cladding material comprising SiO₂ or another solid cladding material having a refractive index between 1 and 1.6, wherein the waveguide includes in a portion along its lengthwise extension a first section having a vertical asymmetric configuration, the asymmetric configuration includes a thin layer of silicon above the waveguide material, the thickness of the thin Si-layer in vertical direction is less than the thickness of the waveguide material in the same vertical direction.

### CROSS-REFERENCE TO RELATED APPLICATIONS

This application is a continuation of International Application No. PCT/CN2015/072814, filed on Feb. 11, 2015, which claims priority to European Patent Application No. EP14161764.7, filed on Mar. 26, 2014. The disclosures of the aforementioned applications are hereby incorporated by reference in their entireties.

### TECHNICAL FIELD

The present invention relates to a field of photonic integrated circuits and in particular to a waveguide configuration, such as a polarization splitter and a polarization splitter and rotator, on the basis of silicon nitride or another semiconductor having a refractive index in the range of silicon nitride.

### BACKGROUND

Silicon photonics is rapidly gaining importance as a generic technology platform for a wide range of applications in telecom, datacom, interconnect and sensing. It allows implementing photonic functions through the use of CMOS compatible wafer-scale technologies on high quality, low cost silicon substrates. However, pure passive silicon waveguide devices still have limited performance in taints of insertion loss, phase noise (which results in channel crosstalk) and temperature dependency. This is due to the high refractive index contrast between the SiO2 (silicon dioxide) cladding and the Si (silicon) core, the non-uniform Si layer thickness and the large thermo-optic effect of silicon.

Silicon nitride-based passive devices offer superior performance, both in terms of insertion loss and phase noise. This is mainly due to the slightly lower refractive index contrast between silicon nitride (n=2) and silicon dioxide (1.5) versus silicon (n=3.5) and silicon dioxide. Both material systems (silicon and silicon nitride waveguides) however have a strong polarization dependency (as compared to e.g. silica waveguides) In order to fabricate polarization independent optical circuits, polarization splitter and rotators (PSRs) are needed as key building blocks. Only a limited number of polarization splitters and rotators in silicon nitride have been published. There are publications based on mode evolution designs.

An example of a polarization splitter and rotator based on mode evolution is reported by Barwicz et al. “Polarization-transparent microphotonic devices in the strong confinement limit”, Nat. Photon., Vol. 1, pp. 57, 2007. The PSR has a good performance over a broad wavelength range and was implemented in a polarization diversity configuration with a ring resonator as optical component. The waveguides consisted of 420 nm thick SiNx. The major drawback of this device, however, and all mode-evolution based PSRs in general is the complex fabrication. It needs multilevel patterning, high aspect ratio features and locally thick SiNx layers.

Chen et al., “Polarization-Diversified DWDM Receiver on Silicon Free of Polarization-dependent Wavelength Shift”, OFC/NFOEC, OW3G.7, 2012 reported a SiNx arrayed waveguide grating in a polarization diversity configuration. However, this is an example in which SiNx is used as a high performance passive waveguide layer on top of an active silicon photonic circuit. The splitting/rotation functionality was implemented in the silicon layer, which is more straightforward.

### SUMMARY

One objective of the present disclosure is to provide a high performance and easy to fabricate polarization dependent mode converter or polarization splitter and rotator on the basis of a silicon nitride waveguide, or a comparable waveguide material.

A first aspect provides a polarization dependent mode converter on a semiconductor basis, having a waveguide made of a waveguide material comprising SiNx or another solid waveguide material with a refractive index between 1.7 to 2.3, such as SiC or SiON, embedded in a cladding material comprising SiO2 or another solid cladding material having a refractive index less than 1.6 and above 1, wherein the waveguide includes in a portion along its lengthwise extension a first section having a vertical asymmetric configuration, the asymmetric configuration includes a thin layer of silicon above the waveguide material, the thickness of the thin Si-layer in vertical direction is less than the thickness of the waveguide material in the same vertical direction.

In the first section, which may also be called “adiabatic taper”, the vertical asymmetric waveguide cross section will convert a TM-polarized mode (TM0) to a first order TE-polarization mode (TE1) while the TE-polarization mode (TE0) remains unaffected. Thus, the adiabatic taper with the vertical asymmetry provides a polarization conversion.

According to a first implementation, the silicon layer has a thickness between 10 nm and 100 nm in the vertical direction. The waveguide material may have a thickness between more than 100 nm and 600 nm, preferably between 300 nm and 500 nm in the same vertical direction.

The proper design of the vertically asymmetric waveguide configuration has the effect that the launched TE0-mode will keep its polarization state while the TM0-modes convert into the TE1-mode and the input and the output for both TE and TM launched polarization modes are properly confined in the waveguide configuration. Thus, the mode conversion is very efficient and is tolerant to slight dimensional variations of the cross section.

According to a second implementation, the thin Si-layer is arranged directly on top of the waveguide material (on top means on top in the vertical direction). According to an alternative implementation, the thin Si-layer may be separated from the top of the waveguide material in vertical direction by a layer of the cladding material. The cladding material between the upper surface of the waveguide material and the lower surface of the thin silicon layer may have a thickness between 1 nm and 100 nm in the vertical direction.

Both configurations with or without separating layer between the waveguide material and the thin Si-layer provides a adequate confinement of the relevant TE- and TM-modes in the waveguide.

According to a third implementation, the thin silicon layer may have a length between 100 μm and 800 μm, preferably between 200 μm and 600 μm in the lengthwise direction of the waveguide. As compared to other silicon nitride waveguides using other top cladding materials to obtain vertical asymmetry (e.g. silicon dioxide bottom cladding and a top cladding of a material with refractive index 1.7), the total length of the asymmetric section may be shorter which is a benefit for the construction of integrated waveguide circuitries.

According to a fourth implementation, the thin silicon layer may have one or more tapering transition regions on a first end and/or on a second end, wherein the first and second ends are defined by the respective input and output sides of the vertical asymmetric portion of the waveguide in a lengthwise direction of the waveguide. The tapering transition regions may have the benefit that any reflection of the electromagnetic wave entering or leaving the vertical asymmetric portion of the waveguide construction can be reduced in comparison to a sharp transition between the symmetric waveguide configuration and the asymmetric waveguide configuration. The one or more transition regions may have the form of a triangle with a peak of the triangle facing away from the respective end of the thin silicon layer. According to a further implementation, the transition regions may include two or more triangles next to each other with the two or more peaks facing away from the respective ends of the silicon layer. According to a preferred implementation, the transition region of the first end includes a single triangle and the transition region of the second end includes two triangles next to each other.

According to a fifth implementation, the transition regions may further include a trapezium forming a transition between the basis of the one or more triangles and the silicon layer of its full width. The trapezium also provides a smooth transition from the outer part of the transition regions to the silicon layer in its middle part between the two ends, where the silicon-layer has its full width.

According to a sixth implementation, the thin silicon layer has a width in a horizontal direction which is equal to the width of the waveguide material in the horizontal direction taken in the same cross section. According to this embodiment, only the transition regions at the first end and/or the second end of the vertically asymmetric part of the waveguide, if any, have a thin silicon layer which has a width less than the corresponding width of the waveguide material in the same cross section.

A second aspect refers to a polarization splitter and rotator including the polarization dependent mode converter of the first aspect of the invention and the second section, wherein the second section includes means to convert a TE1 mode from the polarization dependent mode converter to a TE0 mode and couple it into a first output port and means to couple a TE0 mode from the polarization splitter without conversion in a second output port. The second section of the combined polarization splitter and rotator, thus, provides on the first output port a TE0-mode (being the original TE-mode) and TE0-mode on a second output port (converted from the original TM-mode).

For the second section of the second aspect, vertical asymmetry is not needed. According to a seventh implementation, the second portion includes a vertical symmetry. This has the benefit that it can be easily produced.

The means in the second portion may include a directional coupler in accordance with the eighth implementation of the invention. As an alternative, in accordance with a ninth implementation, the means of the second portion may also include an Y-junction, a phase section to introduce a phase shift between the outputs of the Y-junction and a multi-mode interference coupler. Both implementations provide the effect that a TE1-mode is converted into a TE-0-mode and coupled in the first output port and a TE0-mode is coupled in the second output port without conversion.

### BRIEF DESCRIPTION OF THE DRAWINGS

To illustrate the technical features of embodiments of the present invention more clearly, the accompanying drawings provided for describing the embodiments are introduced briefly in the following. The accompanying drawings in the following description are merely some embodiments of the present invention, but modifications on these embodiments are possible without departing from the scope of the present invention as defined in the claims.

FIG. 1 shows a waveguide cross section of a vertical asymmetric configuration according to embodiments of the invention;

FIG. 2 shows a perspective view of the waveguide configuration of FIG. 1 without the upper cladding material;

FIG. 3 shows a perspective view of the waveguide configuration of FIG. 1 in an alternative embodiment having transition regions;

FIG. 4 shows a top view of a vertically asymmetric waveguide configuration according to an embodiment of the invention without the upper cladding material;

FIG. 5 shows a top view of an asymmetric vertical waveguide configuration without the upper cladding material of a further embodiment;

FIG. 6 shows the propagation of TE- and TM-polarized lights in a vertical asymmetric waveguide configuration of an embodiment of the invention in a cross section on the input side, in a top view, and in a cross section on the output side, respectively;

FIG. 7a shows a diagram for a TM0 to TE1 conversion efficiency as a function of the asymmetric section length for the different waveguide configurations;

FIG. 7b shows cross section views of the different waveguide configurations to which FIG. 7a refers;

FIG. 8a shows a diagram of the conversion efficiency for different waveguide width variations of a 250 μm long asymmetric section;

FIG. 8b shows a graph corresponding to FIG. 8a, but for a 500 μm long asymmetric section;

FIG. 9 shows a top view of the waveguide configuration of a polarization splitter and rotator according to an embodiment of the invention; and

FIG. 10 shows a top view of a waveguide configuration of a polarization splitter and rotator according to an alternative embodiment of the invention.

### DETAILED DESCRIPTION

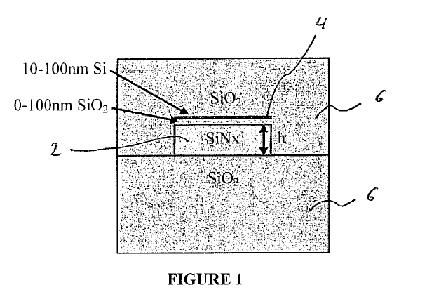

With reference to FIG. 1, the cross section of silicon nitride waveguide within a silica top and silica bottom cladding is shown. A waveguide 2 includes a waveguide material made of silicon nitride (generally referred to as SiNx), such as stochiometric silicon nitride: Si3N4.

A thin silicon layer 4 which has a thickness between about 10 nm to 100 nm is arranged on top of the waveguide material to create vertical asymmetry. The thin silicon layer 4 has the thickness in the vertical direction which is less than the thickness h of the waveguide material 2. The thickness of the waveguide material 2 is dependent on the wavelength for the application. For a wavelength around 1.55 μm, the typical thickness of the waveguide material is about 400 nm.

The waveguide material 2 and the thin silicon layer 4 are embedded in a cladding material 6 which comprise SiO2.

A skilled person in this field will understand that the waveguide materials SiNx which has a refractive index (for a wavelength around 1.5 μm) of about 2 may also be replaced by another waveguide material having a refractive index between 1.7 to 2.3. Examples of such waveguide material which can also form embodiments of the invention are SiC (silicon carbide) or SiOxNy (silicon oxynitride) with values of x and y leading to the desired refractive index. Moreover, the cladding material which comprises SiO2 having a refractive index of about 1.45 may also be replaced by another solid cladding material having a refractive index in the range of above 1 and less than 1.7, for example SiOxNy (silicon oxynitride) with values of x and y leading to the desired refractive index according to different embodiments of the invention.

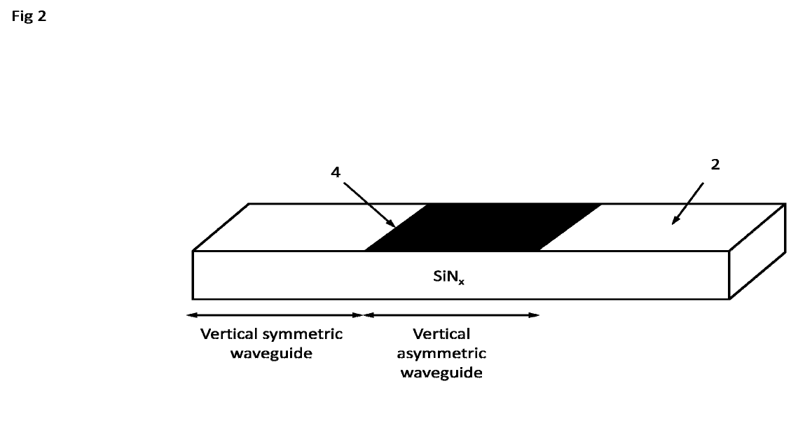

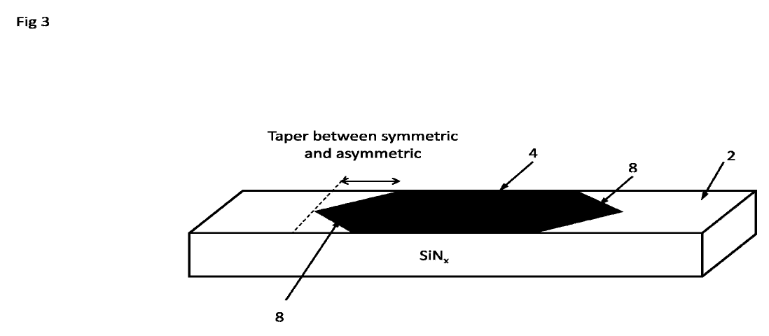

According to a first embodiment, the standard silicon nitride waveguide 2 with a symmetric cladding can be butt-coupled to the vertically asymmetric section as shown in FIG. 2. In this case, there may be a transition loss due to reflection of electromagnetic wave on the sharp transition from the vertical symmetric waveguide section to the vertical asymmetric waveguide section. By adding transition regions 8 which include short tapers, as shown in the embodiment of FIG. 3, the transition loss is negligible. According to the embodiment of FIG. 3, each transition region 8 has the form of a single triangle having the peak facing away from the respective end of the vertical asymmetric waveguide section.

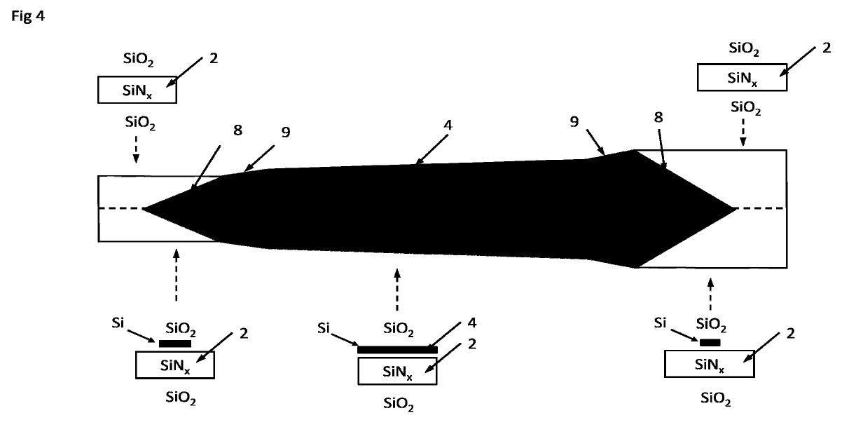

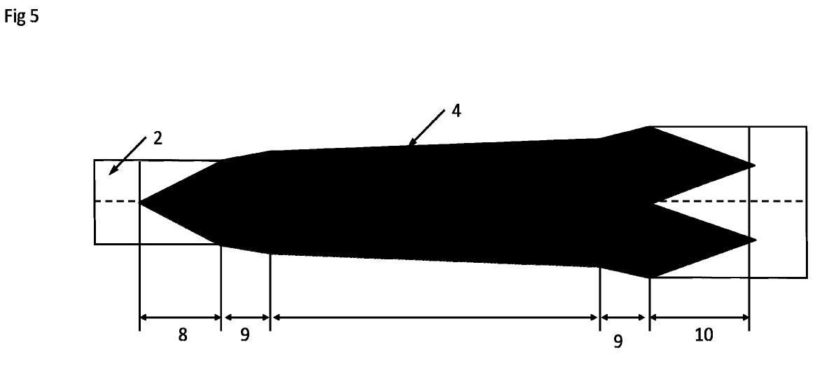

Further embodiments having different kinds of transition regions are shown in FIGS. 4 and 5.

According to the embodiment of FIG. 4, the first transition region 8 includes a single triangle with a peak facing away from the first end of the thin layer 4. Moreover, it includes a transition region in the form of a trapeze 9 between the triangle part and the main part of the thin layer 4. FIG. 4 also shows respective cross sectional views perpendicular to the lengthwise direction of the waveguide. As can be seen from the cross sectional views in the transition region, the thin silicon layer covers the full width of the waveguide material 2, whereas in the main section of the vertically asymmetric waveguide, the thin silicon layer 4 covers only part of the full width of the waveguide material 2.

FIG. 5 shows a further embodiment having the same transition regions 8, 9 on the first end of the asymmetric waveguide section as an embodiment of FIG. 4, whereas the transition region on the second end of the asymmetric waveguide section includes behind a trapezoid region 9 a transition region comprising two triangles 10 which are arranged next to each other. Both triangles have their peaks facing away from the second end of the asymmetric waveguide section.

The waveguide configurations as presented above results in a strong vertical asymmetry. This allows for an efficient polarization-dependent mode conversion as described below.

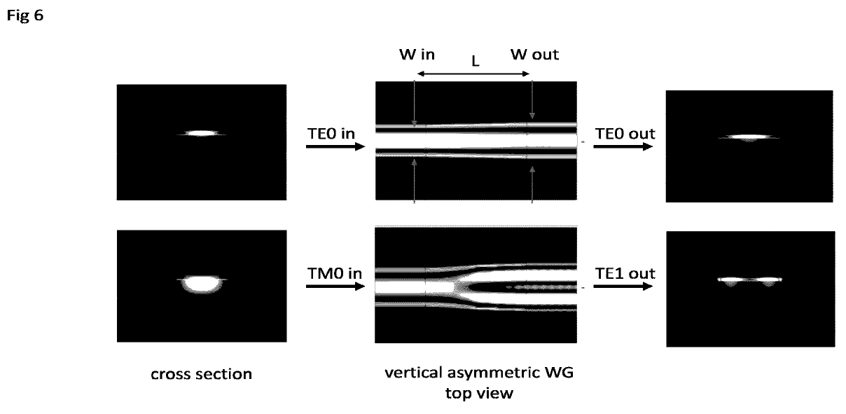

FIG. 6 shows a behaviour of a 200 μm long asymmetric waveguide section in a waveguide cross section consisting of a 400 nm thick SiNx waveguide 2 with a 80 nm thick Si-layer 4 on top. An interfacing layer of the cladding material 6 between the waveguide material 2 and the Si-layer 4 is 5 nm thick. The mode profiles at the input and the output of the vertical asymmetric section for both TE and TM launched polarizations are shown in the first and second row, respectively.

By proper design of the asymmetric waveguide section, the launched TE-mode will keep its polarization state (TE0>TE0) as shown in the first row of FIG. 6, while TM-mode converts into a first order TE-mode (TM0>TE1), as shown in the second row of FIG. 6. Thus, the asymmetric waveguide section provides a polarization dependent mode converter which can be used in different applications, such as in a polarization splitter or a combined polarization splitter and rotator.

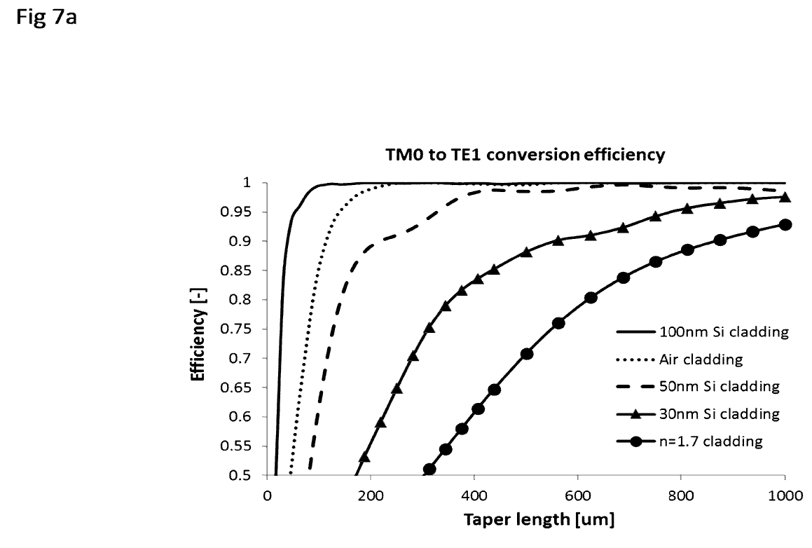

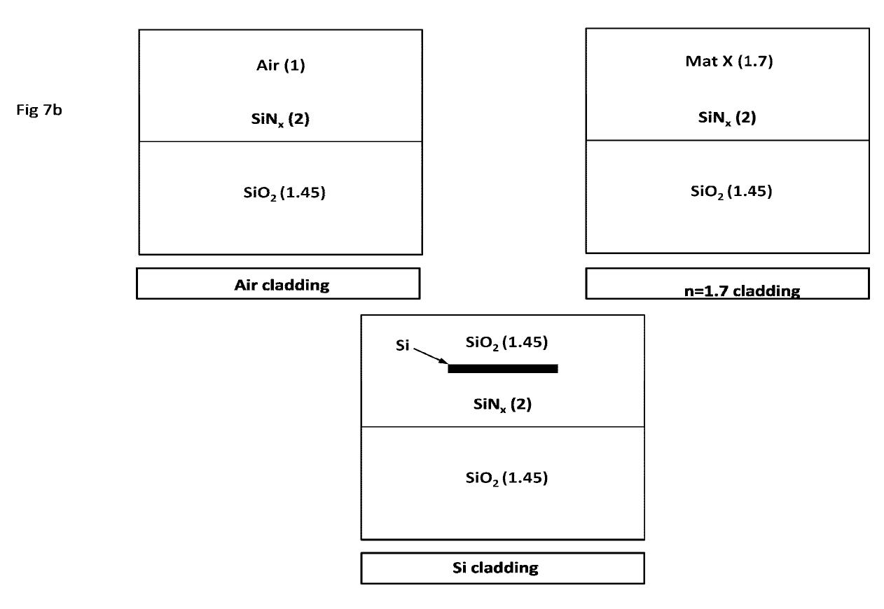

With reference to FIGS. 7a and 7b, the efficiency of the mode conversion is demonstrated. FIG. 7a shows the efficiency for the conversion from the TM-mode to the TE1-mode for different vertical asymmetric waveguide configurations as shown in FIG. 7b in a cross sectional view.

A strong vertical asymmetry could be obtained when the top cladding material is air, i.e. with a refractive index of 1 or another material with a refractive index of 1.7. As can be seen from the graph of FIG. 7a, the air cladding material would provide sufficient conversion efficiency after a length of about 200 μm. However, such an example is difficult to produce because it needs a hermetic package for confining the air cladding in the top region of the cladding material. Another competitive example including an upper cladding material with a material having a refractive index of 1.7 as shown in the graph of FIG. 7a. It can be seen that even after 1,000 μm length, the efficiency of the mode conversion is not satisfying. After 1,000 μm length the conversion efficiency is still below 95%. However, a vertical asymmetric waveguide configuration using a thin silicon layer in accordance with embodiments of the present invention provide better results. As can be seen from the leftmost graphs in FIG. 7a, a 80 nm or 100 nm silicon-layer and a cladding material of SiO2 provide a conversion efficiency close to 100% already after less than 100 μm length. Thus, the embodiments of the invention allow shorter asymmetric waveguide section as compared to the case of a silicon nitride waveguide with an upper cladding material of n=1.7. Moreover, no hermetic package is needed as compared to the competitive example using an upper cladding material of air.

Thus, most cases of a CMOS compatible material having a refractive index 1.7 would make it necessary to use very long asymmetric parts (L>1,000 μm) to obtain high conversion efficiency.

Having an air (n=1) cladding on top of the SiNx waveguide on the other hand results in a strong asymmetry and possible short waveguide configuration. However, a hermetic package is needed in this case in order to keep the refractive index of the upper cladding material constant.

By using an asymmetric waveguide configuration of the present invention including the thin Si-layer 4 very efficient conversation can be obtained. For Si-layer thicknesses as thin as 30 nm, 800 μm long asymmetric waveguide sections result in more than 95% conversion efficiency.

By slightly increasing the thickness to 50 nm, the taper length can even decreased to 400 μm. When increasing the thickness further, the required asymmetric waveguide section length saturates. In the simulation example provided in FIG. 7a, the Si-thickness at which the saturation occurs is about 70 nm to 80 nm. For these thicknesses, even a shorter asymmetric length can be obtained as compared to the length needed having an air cladding. For a 80 nm thick Si-layer, 95% conversion is reached for a length as short as 50 μm.

The simulations presented in FIG. 7a have been done for λ=1.55 μm wavelength, but other wavelengths are also possible, e.g. 1.3 μm to 2 μm.

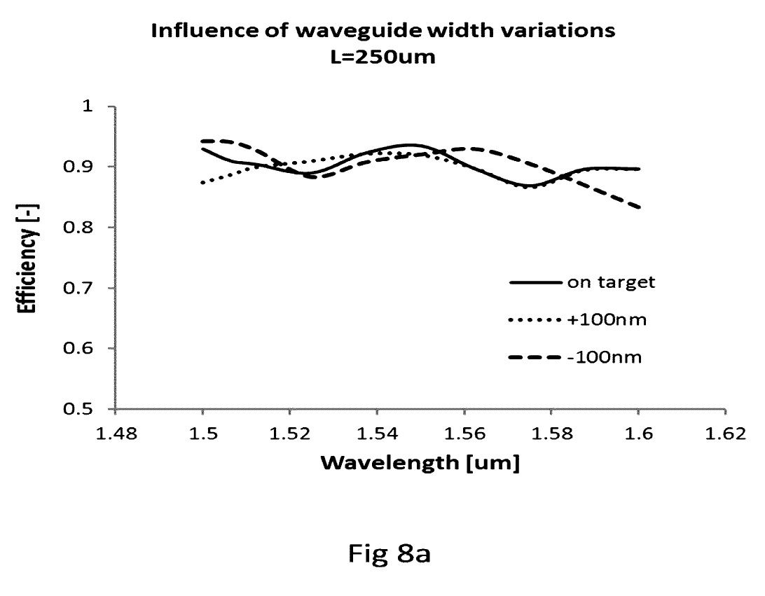

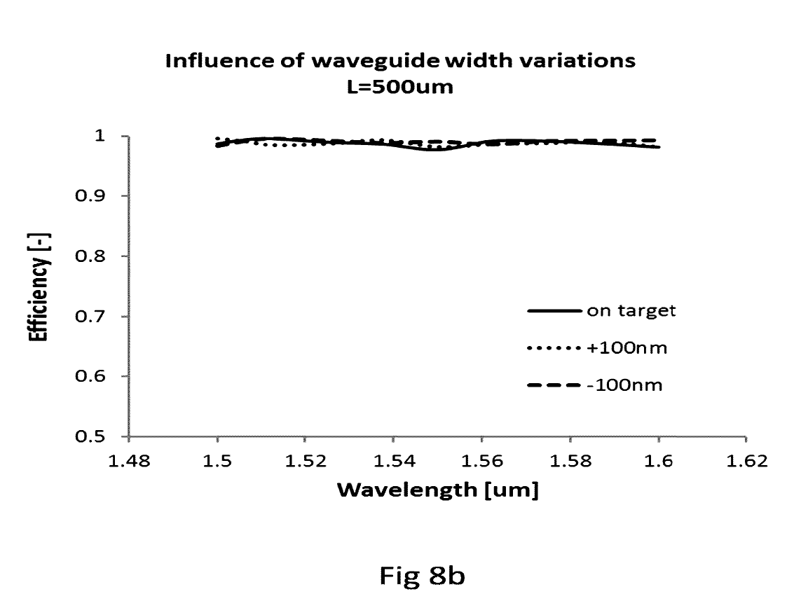

With reference to FIGS. 8a and 8b, the tolerances to fabrication imperfections are demonstrated. As can be seen, if the asymmetric section is chosen sufficiently long, such as 500 μm as shown FIG. 8b, linewidth variations and layer thickness variations of ±10% can easily be tolerated.

FIGS. 8a and 8b show simulation results for the TM0 to TE1 conversion efficiency including waveguide width variations. For these embodiments, the silicon layer thickness is only 50 nm, which requires a slightly longer asymmetric section. The SiNx waveguide thickness for the simulation was 400 nm including an interfacial SiO2 thickness of 5 nm between the top of the waveguide material 2 and the silicon layer 4.

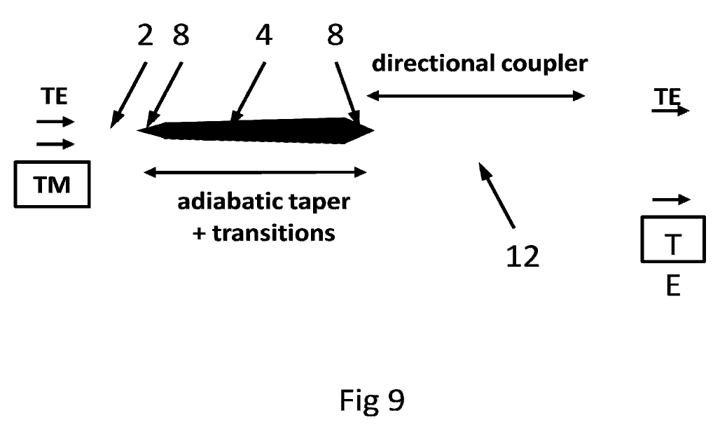

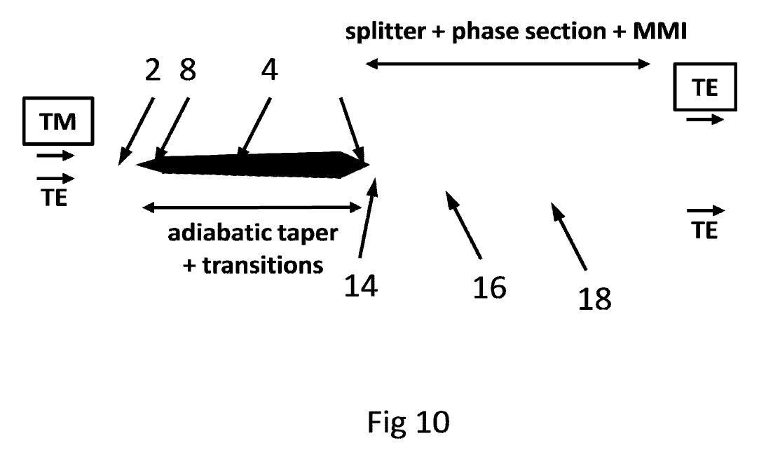

The asymmetric waveguide section of the embodiments of the invention as previously described may form part of a polarization splitter and rotator according to a further aspect of the invention. The polarization splitter and rotator includes a second section, wherein the TE1-mode (being the original TM-mode) needs to be converted to a TE0-mode and coupled to a first output port and the TE0-mode (being the original TE-mode) needs to be coupled to a second output port. For the second section, no vertical asymmetry is needed and a conventional SiNx waveguide with a SiO2 cladding material on top and bottom of the waveguide materials can be used. Possible configurations for the second section in accordance with different embodiments of the invention are presented in FIGS. 9 and 10.

In FIGS. 9 and 10, the black part represents the vertical symmetric cross section consisting of a SiNx waveguide with a SiO2 top and bottom cladding whereas the part denoted by 4 shows the top view of the thin Si-layer including the transition regions 8 which all together form the asymmetric section of the device.

According to the embodiment of FIG. 9, the asymmetric section is followed by a directional coupler 12. Therein, the TM0-mode coupled into the asymmetric section which is converted to a TE1-mode, is coupled into the first output port of the directional coupler, whereas the original TE0-mode on the other hand, which was not converted in the asymmetric section, is coupled to a second output port of the directional coupler.

According to the embodiment of FIG. 10, the same functionality as described for the directional coupler of FIG. 9 is provided by a Y-junction (splitter) 14, a phase section 16 and a multi-mode interference coupler 18. Also for the second section, the vertical asymmetry is not needed and a vertical symmetric construction provides the benefit of easier manufacturing. In the Y-junction 14, the TE0-mode and the TE1-mode from the output of the asymmetric section are split. The phase section 16 provides a phase shift such, as the phase shift of π/2, in one branch of the Y-junction. After the multi-mode interference coupler 18, a TE0-mode which corresponds to the original TE0-mode is coupled to a first output port and a TE0-mode which originates from the TM0-mode is coupled to the second output port.

The foregoing descriptions are only implementation manners of the present invention, but the protection of the scope of the present invention is not limited to this. Any variations or replacements can be easily made through person skilled in the art. Therefore, the protection scope of the present invention should be subject to the protection scope of the attached claims.

What is claimed is:

1. A polarization dependent mode converter, comprising:
a waveguide of a waveguide material embedded within a cladding material, wherein the waveguide material comprises SiNₓ or another solid waveguide material having a refractive index between 1.7 to 2.3, and wherein the cladding material comprises SiO₂ or another solid cladding material having a refractive index between 1 and 1.6; and
wherein the waveguide comprises in a portion along its lengthwise extension a first section having a vertical asymmetric configuration, the vertical asymmetric configuration comprises a thin layer of silicon above the waveguide material, the thickness of the thin silicon layer in vertical direction is less than the thickness of the waveguide material in the same vertical direction.

2. The polarization dependent mode converter of claim 1, wherein the thin silicon layer has a thickness between 10 nm and 100 nm in a vertical direction.

3. The polarization dependent mode converter of claim 1, wherein the waveguide material has a thickness between 100 nm and 600 nm.

4. The polarization dependent mode converter of claim 1, wherein the thin silicon layer is arranged directly on top of the waveguide material.

5. The polarization dependent mode converter of claim 1, wherein the thin silicon layer is separated from the top of the waveguide material in a vertical direction by a layer of the cladding material having a thickness between 1 nm and 100 nm in the vertical direction.

6. The polarization dependent mode converter of claim 1, wherein the thin silicon layer has a length (L) between 10 μm and 2000 μm in the lengthwise direction of the waveguide.

7. The polarization dependent mode converter of claim 1, wherein the thin silicon layer has a tapering transition region on a first end and/or on a second end, wherein the first and second ends are defined by the respective input and output side of the vertically asymmetric portion of the waveguide in the lengthwise direction of the waveguide.

8. The polarization dependent mode converter of claim 7, wherein at least one of the transition region has the form of a triangle with the peak of the triangle facing away from the respective end of the thin silicon layer.

9. The polarization dependent mode converter of claim 7, wherein at least one of the transition regions comprise two or more triangles next to each other with the two or more peaks facing away from the respective end of the thin silicon layer.

10. The polarization dependent mode converter of claim 8, wherein the transition region on the first end comprises a single triangle and the transition region on the second end comprises two triangles next to each other.

11. The polarization dependent mode converter of one of the claim 8, wherein one or both of the transition regions further comprises a trapezium forming a transition between the bases of the one or more triangles and the silicon layer of its full width.

12. The polarization dependent mode converter of claim 1, wherein the thin silicon layer has a width in horizontal direction which is equal to the width of the waveguide material in the horizontal direction taken in the same cross-section.

13. The polarization dependent mode converter of claim 1, wherein the horizontal width of the waveguide tapers from an input region to an output region of the asymmetric section over the full length of the waveguide in the asymmetric section.

14. A polarization splitter and rotator comprising:
a polarization dependent mode converter, comprising:
a waveguide of a waveguide material embedded in a cladding material, wherein the waveguide material comprises SiNₓ or another solid waveguide material having a refractive index between 1.7 to 2.3 and the cladding material comprises SiO₂ or another solid cladding material having a refractive index between 1 and 1.6, and wherein the waveguide comprises in a portion along its lengthwise extension a first section having a vertical asymmetric configuration, the asymmetric configuration comprises a thin layer of silicon above the waveguide material, the thickness of the thin Si-layer in vertical direction is less than the thickness of the waveguide material in the same vertical direction; and a second section comprising:
means for converting a TE1 mode from the polarization dependent mode converter to a TE0 mode and couple it into a first output port and for coupling the TE0 mode from the polarization dependent mode converter without conversion in a second output port.

15. The polarization splitter and rotator of claim 14, wherein the second section comprises vertical symmetry.

16. The polarization splitter and rotator of claim 14, wherein the means comprise a directional coupler.

17. The polarization splitter and rotator of claim 14, wherein the means comprises a Y-junction, a phase section to introduce a phase shift between the branches of the Y-junction and a multi-mode interference coupler.
